(19) United States
(12) Patent Application Publication
(10) Pub. No.: US 2026/0222840 A1
(43) Pub. Date: Jul. 30, 2026

(54) FUNCTIONALITY BASED IMPLICIT ML INFERENCE PARAMETER-GROUP SWITCH FOR BEAM PREDICTION

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Hamed PEZESHKI, San Diego, CA (US); Tao LUO, San Diego, CA (US)

(21) Appl. No.: 19/146,818

(22) PCT Filed: Sep. 26, 2023
(86) PCT No.: PCT/CN2023/121601

§ 371 Date: Jul. 9, 2025

(30) Foreign Application Priority Data
Feb. 24, 2023 (WO) PCT/CN2023/078054

(51) Int. Cl. H04W 24/02; H04W 24/10

(52) U.S. Cl. CPC H04W 24/02; H04W 24/10

(57) ABSTRACT

A method for wireless communication at a user equipment (UE) and related apparatus are provided. In the method, a UE receives, from a network entity, a first indication indicative of a target set of machine learning (ML) functions of a plurality of defined ML functions, and communicates with the network entity based on one or more operational parameters associated with the target set of ML functions indicated from the plurality of defined ML functions. The method provides new signaling frameworks dedicated to ML model switch, and enables a UE to switch parameters for the ML functions with reduced overall signaling overhead. It improves the efficiency of wireless communication.

### CROSS REFERENCE TO RELATED APPLICATION

This application claims the benefit of and priority to PCT International Application No. PCT/CN2023/078054, entitled “FUNCTIONALITY BASED IMPLICIT ML INFERENCE PARAMETER-GROUP SWITCH FOR BEAM PREDICTION” and filed on Feb. 24, 2023, which is expressly incorporated by reference herein in its entirety.

### TECHNICAL FIELD

The present disclosure relates generally to communication systems, and more particularly, to functionality-based implicit machine learning (ML) inference parameter group switch in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include memory and at least one processor coupled to the memory. Based at least in part on information stored in the memory, the at least one processor may be configured to receive, from a network entity, a first indication indicative of a target set of ML functions of a plurality of defined ML functions; and communicate with the network entity based on one or more operational parameters associated with the target set of ML functions indicated from the plurality of defined ML functions.

In an aspect of the disclosure, a method, a computer-readable medium, and an apparatus are provided for wireless communication at a network entity. The apparatus may include memory and at least one processor coupled to the memory. Based at least in part on information stored in the memory, the at least one processor may be configured to provide, for a UE, a first indication indicative of a target set of ML functions of a plurality of defined ML functions; and communicate, based on one or more operational parameters associated with the target set of ML functions, with the UE.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of the AI/ML algorithm in wireless communication.

FIG. 5 is a diagram illustrating example AI/ML functionalities in accordance with various aspects of the present disclosure.

FIG. 6 is a call flow diagram illustrating a method of wireless communication in accordance with various aspects of the present disclosure.

FIG. 7 is a flowchart illustrating methods of wireless communication at a UE in accordance with various aspects of the present disclosure.

FIG. 8 is a flowchart illustrating methods of wireless communication at a UE in accordance with various aspects of the present disclosure.

FIG. 9 is a flowchart illustrating methods of wireless communication at a network entity in accordance with various aspects of the present disclosure.

FIG. 10 is a flowchart illustrating methods of wireless communication at a network entity in accordance with various aspects of the present disclosure.

FIG. 11 is a diagram illustrating an example of a hardware implementation for an example apparatus and/or network entity.

FIG. 12 is a diagram illustrating an example of a hardware implementation for an example network entity.

### DETAILED DESCRIPTION

Using artificial intelligence/machine learning (AI/ML) models for operations such as time domain (TD) beam prediction may come with significant signaling overhead when switching an AI/ML model. For example, the network may send a large amount of information to the user equipment (UE) to initiate and facilitate the model switch, resulting in increased latency and power consumption, especially when handling periodic, semi-persistent, or aperiodic channel state information (CSI) reports. Additionally, considering different AI/ML models that may be locally trained at the UE, each associated with a certain combination of operational parameters, the complexity and overhead of model switching become more pronounced. Example aspects presented herein address these issues by providing an efficient mechanism that can minimize signaling overhead while seamlessly enabling AI/ML model switching in wireless communication.

Various aspects relate generally to a wireless communication system. Some aspects more specifically relate to a functionality-based implicit ML inference parameter group switch for a ML model used in wireless communication. In some examples, a set of functionalities may have a defined set of parameters for an artificial intelligence (AI) or machine learning (ML) model. As an example, various functionalities may include beam prediction, channel state feedback, or positioning, among other examples. The defined set of functionalities may include various levels of sub-functionalities, each having a corresponding set of parameters for the ML model. In some aspects, the various ML parameters for the different functionalities may be defined in a wireless standard. The network may indicate a target set of functionalities to the UE. The UE may then switch between the different parameters for the ML model based on the functionality at the UE, e.g., without additional signaling from the network to switch between the various parameter groups. As an example, the UE may receive, from a network entity, a first indication indicative of a target set of ML functions of a plurality of defined ML functions. The UE may then communicate with the network entity based on one or more operational parameters associated with the target set of ML functions indicated from the plurality of defined ML functions. In some aspects, the UE may configure, based on the first indication, from a plurality of defined operational parameters, the one or more operational parameters associated with the target set of ML functions. In some aspects, the plurality of defined operational parameters may include one or more of a first set of parameters related to UE ML interference behavior for the plurality of ML functions, a second set of parameters related to expected ML input and output for the plurality of ML functions, or a third set of parameters related to assistance information.

Particular aspects of the subject matter described in this disclosure can be implemented to realize one or more of the following potential advantages. In some examples, by receiving a first indication indicative of a target set of ML functions; and communicating with the network entity based on one or more operational parameters associated with the target set of ML functions, the described techniques can be used to provide new signaling frameworks dedicated to artificial intelligence or ML (AI/ML) model switch, and to enable a UE to switch parameters for the ML functions with reduced overall signaling overhead.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

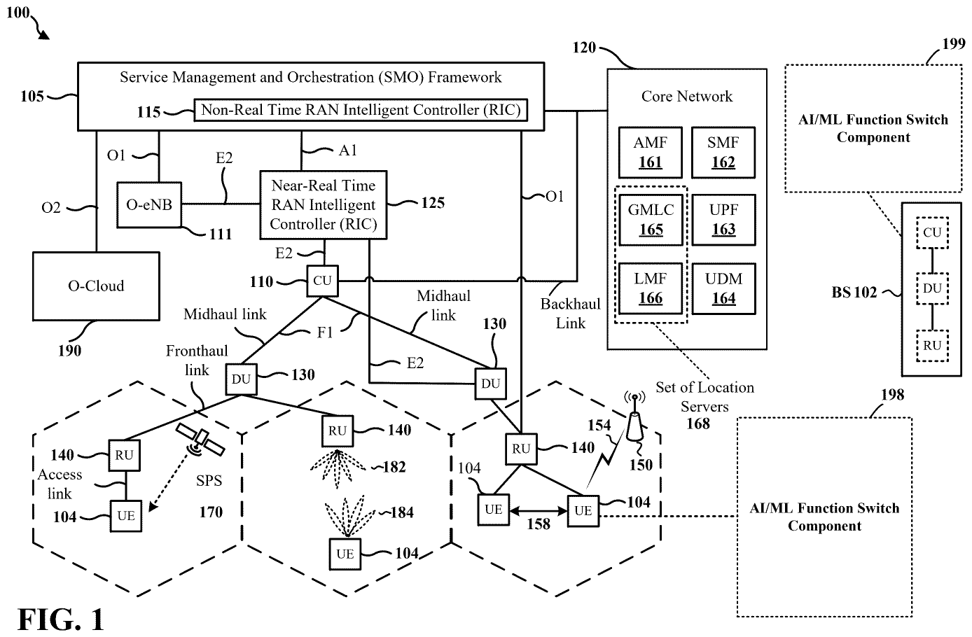

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an AI/ML function switch component 198. The AI/ML function switch component 198 may be configured to receive, from a network entity, a first indication indicative of a target set of ML functions of a plurality of defined ML functions; and communicate with the network entity based on one or more operational parameters associated with the target set of ML functions indicated from the plurality of defined ML functions. In certain aspects, the base station 102 may include an AI/ML function switch component 199. The AI/ML function switch component 199 may be configured to provide, for a UE, a first indication indicative of a target set of ML functions of a plurality of defined ML functions; and communicate, based on one or more operational parameters associated with the target set of ML functions, with the UE. Although the following description may be focused on 5G NR, the concepts described herein may be applicable to other similar areas, such as LTE, LTE-A, CDMA, GSM, and other wireless technologies.

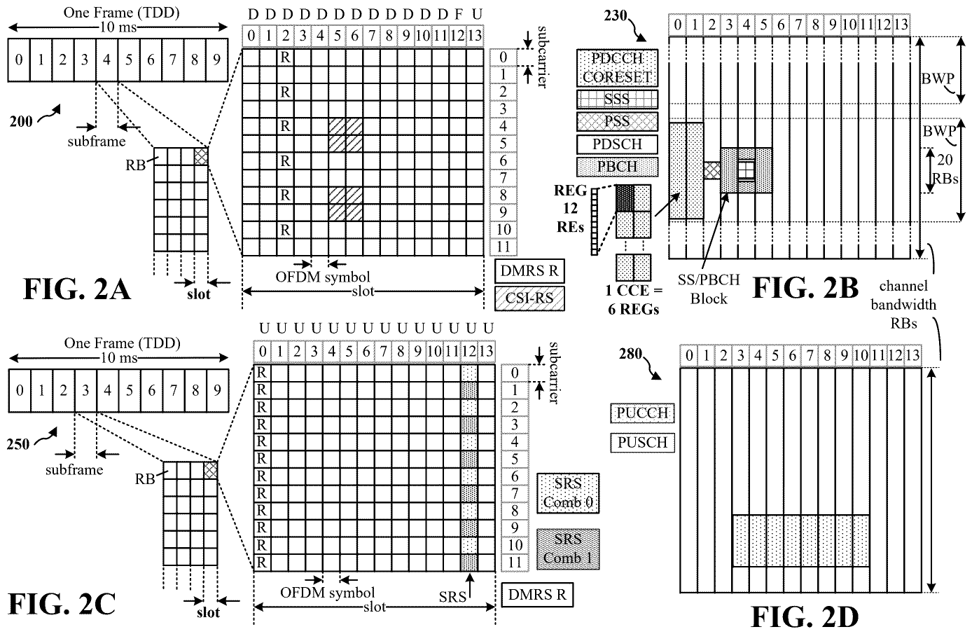

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

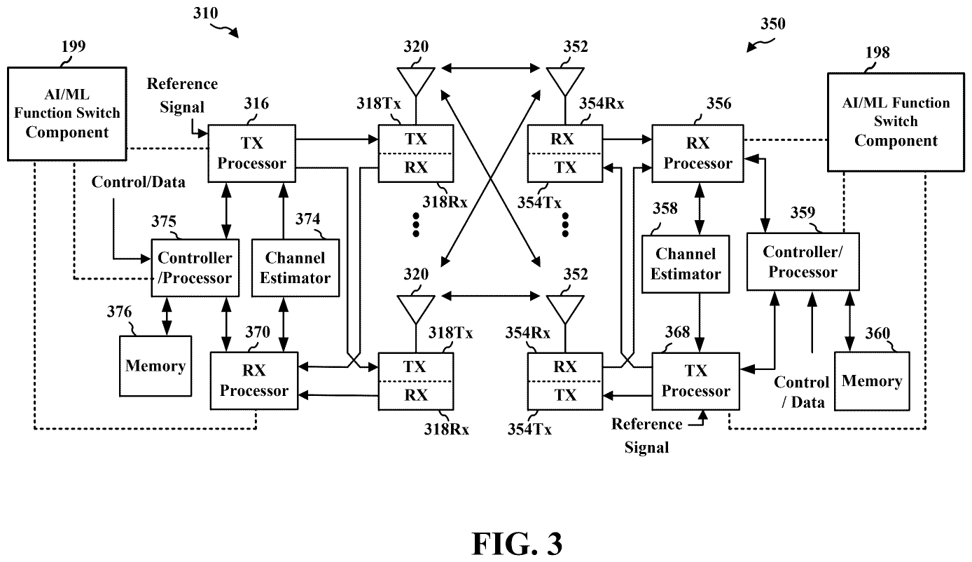

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the AI/ML function switch component 198 of FIG. 1.

At least one of the TX processor 316, the RX processor 370, and the controller/processor 375 may be configured to perform aspects in connection with the AI/ML function switch component 199 of FIG. 1.

As described in connection with 182 and 184 in FIG. 1, a UE and a network may communicate using one or more directional beams. The UE and the network may perform various aspects of beam management in order to select a beam for transmission and reception. In some aspects, beam management may be performed using a tracking reference signal (TRS), e.g., for a UE in an RRC inactive or RRC idle state. For initial access, a UE may use an SSB, e.g., with a wide beam sweeping procedure to identify a beam to use for initial access. For contention based random access (CBRA), a UE may use a random access occasion (RO) and a preamble that corresponds to the selected SSB/beam. In an RRC connected state, the UE and/or network may perform various aspects of beam management, e.g., including a P1, P2, and P3 procedure using SSB or CSI-RS measurements; a U1, U2, and U3 procedure using SRS transmissions and measurement, layer 1 reference signal received power (L1-RSRP) reporting. The network may configure one or more TCI state configurations for the UE, and may indicate a TCI state for the UE from the configured set of TCI states. In some aspects, the UE may provide layer 1 Signal-to-Interference-plus-Noise Ratio (L1-SINR) reporting, which may reduce overhead and latency and allow for CC group beam updates or faster UL beam updates. In some aspects, the UE may communicate with the network using unified TCI states, L1/L2 centric mobility (which may also be referred to as L1/L2 triggered mobility (LTM), dynamic TCI updates, and/or uplink multi-panel selection, maximum permissible exposure (MPE) migration. Beam management may be employed for particular scenarios, such as high speed (e.g., high speed train (HST)), single frequency network (SNF), and multiple transmission reception points (mTRP), among other examples. Based on measurements, a UE may identify a beam failure detection (BFD) and may perform a beam failure recovery (BFD). In some aspects, the BFD or BFR may be for a primary cell (PCell) or a primary secondary cell (PSCell). BFD may be based on a BFD reference signal (BFD-RS) and a PDCCH block error rate (BLER). The BFR may be based on a contention free random access (CFRA). For an SCell, the BFD and BFR may include a link recovery request via a scheduling request (SR) or a medium access control-control element (MAC-CE) based BFR for the SCell. If the BFR is unsuccessful, the UE may identify a radio link failure.

Some wireless communication may include the use of AI or ML at the network and/or at the UE. Among various examples, AI/ML may be used for beam management at a UE and/or a network, including for performing beam predictions in a time domain and/or spatial domain. As another example, AI/ML models may be used for channel state feedback. As another example, AI/ML models may be used for positioning. The use of an AI/ML model may reduce latency or overhead and may improve the accuracy of beam selection. Models may be provided that support various levels of network and UE collaboration and to support various use cases. The use of an AI/ML model may include various aspects such as model training, model deployment, model inference, model monitoring, and model updates.

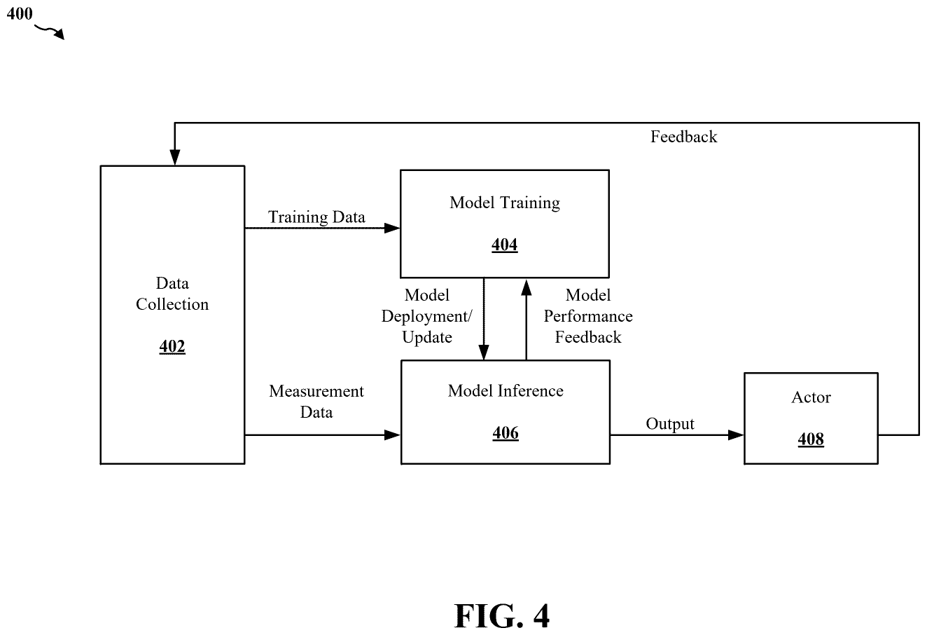

FIG. 4 is an example of the AI/ML algorithm 400 of a method of wireless communication and illustrates various aspects model training, model inference, model feedback, and model update. The AI/ML algorithm 400 may include various functions including a data collection 402, a model training function 404, a model inference function 406, and an actor 408.

The data collection 402 may be a function that provides input data to the model training function 404 and the model inference function 406. The data collection 402 function may include any form of data preparation, and it may not be specific to the implementation of the AI/ML algorithm (e.g., data pre-processing and cleaning, formatting, and transformation).

The examples of input data may include, but are not limited to, measurements, such as RSRP measurements or other TCI candidate information, channel measurements, positioning measurements, from entities including UEs or network nodes, feedback from the actor 408 (e.g., which may be a UE or network node), output from another AI/ML model. The data collection 402 may include training data, which refers to the data to be sent as the input for the AI/ML model training function 404, and inference data, which refers to be sent as the input for the AI/ML model inference function 406.

The model training function 404 may be a function that performs the ML model training, validation, and testing, which may generate model performance metrics as part of the model testing procedure. The model training function 404 may also be responsible for data preparation (e.g., data pre-processing and cleaning, formatting, and transformation) based on the training data delivered or received from the data collection 402 function. The model training function 404 may deploy or update a trained, validated, and tested AI/ML model to the model inference function 406, and receive model performance feedback from the model inference function 406. As described above, there may be various functionalities to be performed by an AI/ML model for wireless communication

The model inference function 406 may be a function that provides the AI/ML model inference output (e.g., predictions or decisions). The model inference function 406 may also perform data preparation (e.g., data pre-processing and cleaning, formatting, and transformation) based on the inference data delivered from the data collection 402 function. The output of the model inference function 406 may include the inference output of the AI/ML model produced by the model inference function 406. The details of the inference output may be use case specific. As an example, the output may include a beam prediction for beam management. The prediction may be for the network or may be for the UE. The output may include positioning information, e.g., for the UE. The output may include channel state feedback. The output may include various output for different functionalities. In some aspects, the actor may be a component of the base station or of a core network. In other aspects, the actor may be a UE in communication with a wireless network.

The model performance feedback may refer to information derived from the model inference function 406 that may be suitable for the improvement of the AI/ML model trained in the model training function 404. The feedback from the actor 408 or other network entities (via the data collection 402 function) may be implemented for the model inference function 406 to create the model performance feedback.

The actor 408 may be a function that receives the output from the model inference function 406 and triggers or performs corresponding actions. The actor may trigger actions directed to network entities including the other network entities or itself. The actor 408 may also provide feedback information that the model training function 404 or the model inference function 406 to derive training or inference data or performance feedback. The feedback may be transmitted back to the data collection 402.

The network may use machine-learning algorithms, deep-learning algorithms, neural networks, reinforcement learning, regression, boosting, or advanced signal processing methods for aspects of wireless communication including various functionalities such as beam management, CSF, or positioning, among other examples.

In some aspects described herein, the network may train one or more neural networks to learn the dependence of measured qualities on individual parameters. Among others, examples of machine learning models or neural networks that may be included in the network entity include artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; bayesian networks; genetic algorithms; Deep convolutional networks (DCNs) configured with additional pooling and normalization layers; and Deep belief networks (DBNs).

A machine learning model, such as an artificial neural network (ANN), may include an interconnected group of artificial neurons (e.g., neuron models), and may be a computational device or may represent a method to be performed by a computational device. The connections of the neuron models may be modeled as weights. Machine learning models may provide predictive modeling, adaptive control, and other applications through training via a dataset. The model may be adaptive based on external or internal information that is processed by the machine learning model. Machine learning may provide non-linear statistical data model or decision making and may model complex relationships between input data and output information.

A machine learning model may include multiple layers and/or operations that may be formed by the concatenation of one or more of the referenced operations. Examples of operations that may be involved include extraction of various features of data, convolution operations, fully connected operations that may be activated or deactivated, compression, decompression, quantization, flattening, etc. As used herein, a “layer” of a machine learning model may be used to denote an operation on input data. For example, a convolution layer, a fully connected layer, and/or the like may be used to refer to associated operations on data that is input into a layer. A convolution A×B operation refers to an operation that converts a number of input features A into a number of output features B. “Kernel size” may refer to a number of adjacent coefficients that are combined in a dimension. As used herein, “weight” may be used to denote one or more coefficients used in the operations in the layers for combining various rows and/or columns of input data. For example, a fully connected layer operation may have an output y that is determined based at least in part on a sum of a product of input matrix x and weights A (which may be a matrix) and bias values B (which may be a matrix). The term “weights” may be used herein to generically refer to both weights and bias values. Weights and biases are examples of parameters of a trained machine learning model. Different layers of a machine learning model may be trained separately.

Machine learning models may include a variety of connectivity patterns, e.g., any feed-forward networks, hierarchical layers, recurrent architectures, feedback connections, etc. The connections between layers of a neural network may be fully connected or locally connected. In a fully connected network, a neuron in a first layer may communicate its output to each neuron in a second layer, and each neuron in the second layer may receive input from every neuron in the first layer. In a locally connected network, a neuron in a first layer may be connected to a limited number of neurons in the second layer. In some aspects, a convolutional network may be locally connected and configured with shared connection strengths associated with the inputs for each neuron in the second layer. A locally connected layer of a network may be configured such that each neuron in a layer has the same or similar connectivity pattern but with different connection strengths.

A machine learning model or neural network may be trained. For example, a machine learning model may be trained based on supervised learning. During training, the machine learning model may be presented with input that the model uses to compute to produce an output. The actual output may be compared to a target output, and the difference may be used to adjust parameters (such as weights and biases) of the machine learning model in order to provide an output closer to the target output. Before training, the output may be incorrect or less accurate, and an error, or difference, may be calculated between the actual output and the target output. The weights of the machine learning model may then be adjusted so that the output is more closely aligned with the target. To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error or to move the output closer to the target. This manner of adjusting the weights may be referred to as back propagation through the neural network. The process may continue until an achievable error rate stops decreasing or until the error rate has reached a target level.

The machine learning models may include computational complexity and substantial processors for training the machine learning model. An output of one node is connected as the input to another node. Connections between nodes may be referred to as edges, and weights may be applied to the connections/edges to adjust the output from one node that is applied as input to another node. Nodes may apply thresholds in order to determine whether, or when, to provide output to a connected node. The output of each node may be calculated as a non-linear function of a sum of the inputs to the node. The neural network may include any number of nodes and any type of connection between nodes. The neural network may include one or more hidden nodes. Nodes may be aggregated into layers, and different layers of the neural network may perform different kinds of transformations on the input. A signal may travel from input at a first layer through the multiple layers of the neural network to output at the last layer of the neural network and may traverse layers multiple times.

The signaling overhead for an AI/ML model switch may be large. The network may send a large amount of information to the UE in order to enable the UE to switch to and begin using a different AI/ML model. Using the AI/ML model switch for Time Division (TD) beam prediction as an example, the UE may report its predicted L1-RSRPs, via CSI reports, for example, regarding N future occasions for X beams (where N and X are integers). Additionally, the UE may further report M contiguous historical measurement occasions with respect to Y beams and the basic beam management (BM) cycle of P ms (where M, Y, and P are integers), based on which the future L1-RSRPs may be predicted. Different AI/ML models may have been locally trained at a UE, e.g., as described in connection with FIG. 4, and each model may be associated with a particular combination of {M, N, X, Y, P}. The base station may further determine the mode to which the UE is to be switched, depending on different observations (e.g., out-loop performance or AI/ML performance monitoring observations).

To establish such an AI/ML model switch, the base station may transmit a large amount of signaling to the UE. For example, for periodic channel state information (P-CSI) reports, a UE may be configured with a large number of CSI report settings associated with different operation modes, which may lead to large amounts of configuration overhead. For semi-persistent CSI (SP-CSI) reports, a UE may receive an enhanced MAC-CE indicating a combination of {M, N, X, Y, P}, which is based on multiple preconfigured CSI report settings and may lead to a large amount of signaling overhead. For aperiodic CSI (AP-CSI) reports, a UE be configured with a large number of AP CSI triggering states to reflect different combinations of {M, N, X, Y, P}, which may be limited as activatable AP CSI triggering states may be limited due to a DCI overhead restriction.

Example aspects herein provide methods and apparatus for functionality-based implicit ML inference parameter group switch. In some aspects, new signaling frameworks dedicated to the AI/ML model switch are introduced. Based on the new signaling frameworks, the parameters for the AI/ML model, such as those discussed above, may be implicitly switched based on reduced overall signal overhead with low specification changes. The proposed methods may be described in the context of beam prediction, but the methods are not limited herein and may be generally applicable to other use cases.

In some aspects, in the methods for functionality based implicit ML inference parameter group switch, a set of functionalities may be defined for AI/ML based UE operation. In some aspects, the set of functionalities may be defined in a wireless standard or may be otherwise known by a UE and a network without being signaled to the UE by the network. The defined functionalities and their corresponding AI/ML model parameters may be referred to as being “predefined” in some aspects, because they are defined and known to the UE and the network rather than being signaled to the UE by the network. In some aspects, the defined functionalities may include a number of main functionalities, which may include, for example, beam prediction, CSF, and/or positioning. Each of these main functionalities may further include a number of functionalities for the next hierarchy level, which may be referred to as the “sub-functionalities.” For example, the main functionality of beam prediction may further include the sub-functionalities of time domain (TD) beam prediction, spatial domain (SD) beam prediction, and frequency domain (FD) beam prediction. Each of the sub-functionalities may further include one or more lower hierarchy levels of functionalities. For example, a sub-functionality may include multiple functionalities of the next hierarchy level, which may be referred to as, for example, “sub-sub-functionalities.” The operational parameters for these functionalities may include parameters that define specific UE behaviors, expected AI/ML input/output, and expected assistance information from a base station, or reference signals. The operational parameters may also be defined in a wireless standard. As used herein, the term “standard” may refer to a set of technical specifications or guidelines in wireless communication that have been agreed upon in the industry.

In some aspects, a UE may receive indications from a base station requesting the UE to switch to one or more of the defined functionalities (e.g., one or more of the main functionalities or the sub-functionalities), such that the operational parameters associated with the requested functionalities (e.g., the requested main functionalities or sub-functionalities) may be implicitly switched without further signaling.

In some aspects, the defined functionalities (e.g., the functionalities defined in the wireless standard) may include one or more of: TD/SD/FD beam prediction, AI/ML-based CSI feedback, and/or AI/ML-based positioning.

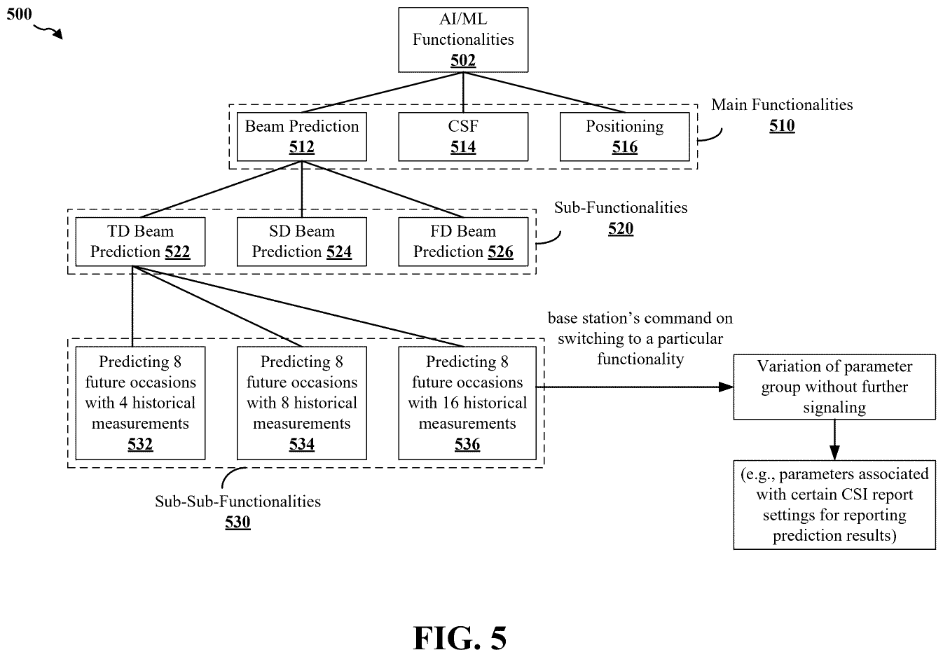

FIG. 5 is a diagram 500 illustrating example AI/ML functionalities in accordance with various aspects of the present disclosure. As shown in FIG. 5, the AI/ML functionalities 502 may include several main functionalities 510. The main functionalities 510 may include, for example, the beam prediction function 512, the CSF function 514, and the positioning function 516. Each of the main functionalities 510 may further include a lower hierarchy level of functions, which may be referred to as the sub-functionalities 520. For example, the beam prediction function 512 may including sub-functionalities of TD beam prediction 522, SD beam prediction 524, and FD beam prediction 526. Each of the sub-functionalities 520 may further include a lower hierarchy level of functions, which may be referred to as the sub-sub-functionalities 530, for example. Upon receiving a command from, for example, a base station, on switching to a particular functionality, the UE may select a corresponding parameter group for performing the particular functionalities without further signaling. For example, the parameter group may include parameters associated with certain CSI report settings for reporting prediction results for a particular functionality.

The functionality switch command to the UE may be implemented in various ways. In some aspects, among the defined AI/ML functionalities (e.g., the functionalities defined in the wireless standard), a UE may be configured with a certain subset of the defined functionalities through RRC. The subset of the defined functionalities may be based on the capabilities supported by the UE. For example, the UE may report the functionalities for which it supports AI/ML models as the UE capabilities that the UE provides to the network during the initial access. The base station may configure the UE for one or more of the AI/ML functionalities that the UE supports. As an example, the base station may configure the UE for a subset of functionalities from the functionalities the UE can support based on the UE-reported capabilities. The base station may signal the defined functionalities or sub-functionalities to the UE in RRC signaling, for example. The RRC signaling may indicate the ML for the functionality with reference to the defined AI/ML model parameters for the indicated functionality or sub-functionality. In some aspects, a maximum number of base station configurable sub-functionalities for a certain main functionality may be defined, and the base station may determine which functionalities among the maximum number of sub-functionalities to RRC configured for the UE.

In some aspects, the network may indicate or activate one or more of the defined AI/ML functionalities (e.g., the functionalities defined in the wireless standard) that were previously indicated in RRC signaling, with one or more MAC-CEs to the UE to activate one or more subsets of these RRC configured, defined functionalities. In one example, the candidate AI/ML functionalities may first be indexed according to defined rules (e.g., defined rules in a wireless standard or otherwise known to the UE), and the UE may be indicated by a single MAC-CE, which may include the functionality IDs of the to-be-activated functionalities, to activate the one or more subsets of these functionalities. In another example, the UE may be indicated to activate one or more subsets of these functionalities via multiple MAC-CEs. Each MAC-CE format of the multiple MAC-CEs may be associated with a dedicated main functionality or a sub-functionality within a main functionality. In some examples, a MAC-CE may identify the main functionality or sub-functionality the MAC-CE is associated with, then the remaining payload may further indicate the candidate functionality IDs that are to be activated.

In some aspects, the network may further indicate to the UE to switch to or apply a particular AI/ML functionality among the RRC configured set and/or the MAC-CE activated subset. For example, among the defined AI/ML functionalities (e.g., the functionalities defined in the wireless standard), the RRC configured functionalities, and/or the MAC-CE activated functionalities, a UE may be further indicated via one or more MAC-CEs or one or more DCIs to switch to one or more subsets of these functionalities. In one example, the candidate AI/ML functionalities may first be indexed, e.g., according to defined rules or configuration, and the UE may receive a single MAC-CE or a single DCI, which may include the functionality IDs of the to-be-switched-to functionalities. In another example, the UE may be indicated to switch to one or more subsets of these functionalities via multiple MAC-CEs or multiple DCIs. Each MAC-CE (or DCI) format of the multiple MAC-CE (or DCI) formats may be associated with a dedicated main functionality or a sub-functionality within a main functionality. In some examples, a MAC-CE (or DCI) may identify the main functionality or sub-functionality the MAC-CE (or DCI) is associated with, then the remaining payload may further indicate the candidate functionality IDs of the functionalities to be switched to.

In some aspects, one or more signaling frameworks described above (e.g., the RRC configuration for a set of the defined functionalities having associated AI/ML models, MAC-CE activation of a subset of the RRC configured set, and/or MAC-CE or DCI indication to apply or switch to one or more of the configured and/or activated functionalities and corresponding AI/ML model parameters) may be combined to signal the UE to switch to a particular AI/ML functionality. For example, a UE may switch to a particular, defined AI/ML functionality based on a MAC-CE or DCI without an RRC configuration or MAC-CE activation. The UE may switch to a particular, defined AI/ML functionality based on a MAC-CE activation and DCI indication without an RRC configuration of an initial set. The UE may switch to a particular, defined AI/ML functionality based on an RRC configuration and a MAC-CE or DCI indication. The UE may switch to a particular, defined AI/ML functionality based on an RRC configured set, a MAC-Ce activation of a subset, and a DCI indication from the activated subset of the RRC configured set of defined AI/ML functionalities.

The operational parameters associated with the AI/ML functionalities may be defined, for example, in the wireless standard. Among other examples, the AI/ML functions may include channel characteristic prediction, beam prediction, positioning prediction, etc. The operational parameters may include at least one of: the parameters associated with UE AI/ML inference behaviors, the parameters associated with expected AI/ML input or output, and the parameters associated with expected assistance information from the network or RSs.

The parameters associated with UE AI/ML inference behaviors may include a prediction parameter indicating a prediction type associated with the plurality of defined ML functions. For example, the prediction type may indicate that a beam prediction is on the spatial domain only, on a combination of the spatial domain and the temporal domain, on the frequency domain only, on a combination of the frequency domain and the temporal domain, on a combination of the spatial domain and the frequency domain, or on a combination of the spatial domain, the frequency domain, and the temporal domain.

The parameters associated with UE AI/ML interference behaviors may further include a feedback parameter indicating feedback for channel characteristic prediction associated with the plurality of defined ML functions. For example, the feedback parameter may indicate whether a UE is to feedback the predicted L1-RSRP, the predicted L1-SINR, the Channel Quality Indicator (CQI) for a channel between the UE and the network entity, the rank indicator (RI), or feedback the predicted top-K prediction target resources in terms their L1-RSRPs/L1-SINRs among the candidate prediction target resources.

The parameters associated with UE AI/ML interference behaviors may further include an accuracy parameter indicating an expected prediction accuracy or a confidence level associated with the plurality of defined ML functions. For example, the accuracy parameter may indicate whether a UE is to provide feedback on the confidence levels associated with the prediction results it reported. The accuracy parameter may further indicate the expected prediction accuracy or confidence level for the UE to meet, and, if the expected prediction accuracy or confidence level cannot be met during inference, whether the UE is to report such an issue.

The parameters associated with expected AI/ML input or output may include a first resource indicator for first measurement resources for inputs associated with the plurality of defined ML functions, a second resource indicator for predicted target resources for outputs associated with the plurality of defined ML functions, and a characteristic parameter indicating a relationship between the first measurement resources and the predicted target resources. The first resource indicator may include the number of measurement resources to be used for AI/ML input and whether the number of measurement resources would vary across different measurement occasions, and, if they do, the variation pattern of the measurement resources. The second resource indicator may indicate the number of prediction target resources or beams to be derived from the AI/ML output and whether such output would vary across different prediction target occasions, and, if they do, the variation pattern of the prediction targets. The characteristic parameter may indicate whether the measurement resources are a subset of the prediction target resources, or whether the measurement resources are non-overlapping with the prediction target resources, in terms of the beam pointing directions and/or the beam widths.

The parameters associated with expected assistance information from the network or RSs may include a signaling indicator for an indication request associated with the plurality of defined ML functions, a target indicator for transmission of target results associated with the plurality of defined ML functions, and a measurement indicator for measurement of the target results associated with the plurality of defined ML functions.

In some aspects, the signaling indicator may indicate whether the UE may expect to be further signaled from the base station with transmit beam information regarding measurement resources and/or prediction targets, and, if it does, whether the signaling is based on explicit beam width and pointing direction, or based on transmit panel structure and the precoding codebook, or based on implicit indications (e.g., based on only beam neighboring information for measurement resources and/or prediction targets, or linear combination based associations btw the measurement resources and prediction targets). The target indicator may indicate whether the UE may expect the target prediction resource or beam to be transmitted (although less frequently comparing to the measurement resource for identifying the prediction results), or not transmitted at all. The target indicator may further indicate, if the UE may expect the target prediction resource/beam to be transmitted, the frequency the UE may expect for such transmission. The measurement indicator may indicate whether the UE is expected to be measuring the actually transmitted prediction targets (for performance monitoring) via SSBs, via CSI-RSs, or via DMRSs.

In some aspects, the operational parameters associated with the AI/ML functionalities may include parameters that are specific to particular AI/ML functionalities. For example, when the ML function includes the TD beam prediction, the parameters associated with UE AI/ML inference behaviors may further include one or more of: a historical parameter indicating an association of historically measured resources with a set of spatial transmit filters associated with the ML function, and an accuracy adjustment parameter indicating an adjustment of accuracies or confidence levels for different future prediction occasions of the ML function. In some aspects, the historical parameter may indicate whether the UE is to expect that the historically measured measurement resources are associated with the same set of spatial transmit filters for the same measurement resource across different measurement occasions. The accuracy adjustment parameter may indicate different accuracies or confidence levels for different future prediction occasions (e.g., a lower the accuracy or confidence level may be associated with a further prediction occasion).

For example, when the ML function includes the TD beam prediction, the parameters associated with expected AI/ML input and output may further include one or more of: an interval parameter indicating intervals between adjacent measurement occasions and between adjacent prediction occasions, and a future prediction parameter indicating a number of future prediction occasions. In some aspects, the interval parameter may indicate at least one of intervals between adjacent measurement occasions and intervals between adjacent prediction occasions. The future prediction parameter may indicate the number of future prediction occasions for the UE to predict towards based on a certain number of measurement occasions.

In some aspects, when the ML function includes the FD beam prediction, the parameters associated with UE AI/ML inference behaviors may further include one or more of: frequency ranges (FRs) or CCs conveying second measurement resources and prediction targets, an accuracy adjustment parameter indicating an adjustment of accuracies or confidence levels for different FRs or CCs of the ML function. In some examples, the accuracy adjustment parameter may indicate different accuracies or confidence levels for different FR/CC distances (e.g., the greater the inter-FR/CC difference corresponds to the lower the accuracy or confidence level).

In some aspects, when the ML function includes the FD beam prediction, the parameters associated with the expected AI/ML input and output may further include a TD association parameter indicating a first association of the prediction target with TD occasions of the ML function. In some examples, the TD association parameter may indicate whether the prediction target is about the same TD occasion as that associated with the measurement resource (e.g., for pure FD prediction), or about future TD occasion(s) (e.g., for FD and TD prediction).

In some aspects, when the ML function includes the FD beam prediction, the parameters associated with expected base station assistant information or RSs may further include a co-location indicator indicating a second association of third measurement resources with antennas, and a location parameter indicating location information of the antennas of the network entity. In some examples, the co-location indicator may indicate whether the measurement resources and prediction targets are associated with co-located antennas, or associated with non-located antennas. The location parameter may indicate, in the case that the measurement resources and prediction targets are associated with non-located antennas, specific location/distance information regarding such antennas.

In some aspects, for certain main functionalities or sub-functionality for UE-side channel characteristics prediction (including TD/SD/FD beam prediction), the UE may be configured with a single CSI report setting. The CSI report setting may additionally include the ID of the corresponding main functionality or sub-functionality. In some examples, the coordinated multipoint receptions (CMRs) associated with the CSI report setting may be used as inputs to identify the predicted channel characteristics. The parameter reportQuantity associated with the CSI report setting may include the predicted channel characteristics. In some aspects, upon receiving an AI/ML functionality switch command associated with the considered main functionality or sub-functionality ID, the parameters associated with the CSI report setting may be adaptively switched without further signaling from, for example, a base station.

In one example, the CSI report setting may be associated with a set of sub-functionalities for TD beam prediction. The UE may report via the associated CSI report with respect to the predicted future L1-RSRPs regarding N future occasions for X beams for a certain reporting instance based on M contiguous historical measurement occasions with respect to Y beams, considering basic cycle=P ms among adjacent prediction/measurement occasions. For example, referring to FIG. 5, for TD beam prediction 522, the UE may report via the associated CSI report with respect to the predicted future L1-RSRPs regarding 8 future occasions for 4 historical measurements (at 532), regarding 8 future occasions for 8 historical measurements (at 534), or regarding 8 future occasions for 16 historical measurements (at 536).

The set ID of the functionalities may be configured in the CSI report setting. Thus, the set of sub-functionalities may be defined in the wireless standard by the combination of, for example, {M, N, X, Y, P}. The CSI report setting may contain configurations meeting the maximum values associated with {M, N, X, Y, P}. For example, CMRs may be configured more than actually expected with orders, and the leading M ones may be expected based on the network's indication regarding the sub-functionality.

For the set of sub-functionalities, a UE may expect to be further indicated with assistant information regarding beam pointing direction adjacency information regarding the CMRs and prediction target resources, while no further explicit information is expected. Thus, the set of sub-functionalities may be further defined in the wireless standard by these types of assistant information.

For the set of sub-functionalities, whether the UE may expect to receive actual RSs associated with the prediction targets can be altered as a parameter for the sub-functionalities. Thus, the sub-functionalities may be further defined in the wireless standard by being able to be controlled by whether actual RSs associated with the prediction targets are to be received. This may be further based on the fact that the wireless standard may define that the CSI report setting is to have preconfigured potential CSI-RS resources associated with the prediction target resources to convey the potential actual transmission of such prediction targets. Such CSI-RS resources, however, may not be expected to be received if the network's indications regarding the sub-functionality imply no such actual RS transmission.

Additionally, a base station may use a dedicated MAC-CE. The first part of the MAC-CE payload may contain the set ID of the sub-functionalities, and the second part of the MAC-CE payload may contain the above parameters or a certain sub-functionality ID in the set. The UE may adaptively alter the parameters associated with the CSI report setting without receiving dedicated commands on altering the CSI report setting.

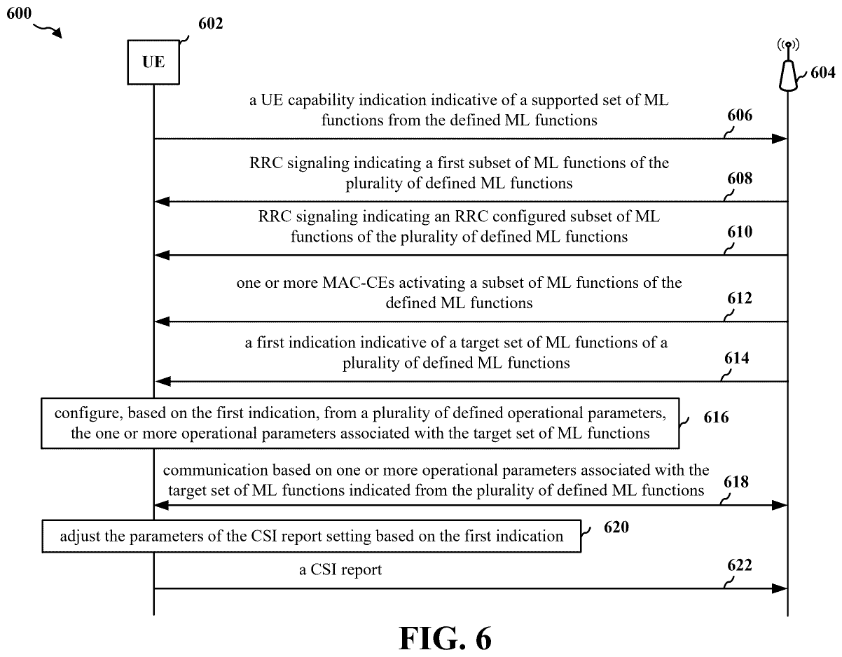

FIG. 6 is a call flow diagram 600 illustrating a method of wireless communication in accordance with various aspects of this present disclosure. Although aspects are described for a base station 604, the aspects may be performed by a base station in aggregation and/or by one or more components of a base station 604 (e.g., such as a CU 110, a DU 130, and/or an RU 140).

As shown in FIG. 6, a UE 602 may transmit a UE capability indication to a base station 604. The UE capability indication may indicate a supported set of ML functions from the defined ML functions. For example, referring to FIG. 5, the supported set of ML functions may be TD beam prediction 522, SD beam prediction 524, and FD beam prediction 526.

At 608, the UE 602 may receive from the base station 604 RRC signaling indicating a first subset of ML functions of the plurality of defined ML functions. For example, referring to FIG. 5, the first subset of ML functions may be TD beam prediction 522.

At 610, the UE 602 may receive from the base station 604 RRC signaling indicating an RRC configured subset of ML functions of the plurality of defined ML functions. For example, referring to FIG. 5, the RRC configured subset of ML functions may be SD beam prediction 524.

At 612, the UE 602 may receive from the base station 604 one or more MAC-CEs activating a subset of ML functions of the defined ML functions. For example, referring to

At 614, the UE 602 may receive from the base station 604 a first indication indicative of a target set of ML functions of a plurality of defined ML functions. For example, referring to FIG. 5, the first indication may indicate the sub-sub-functionalities 532 and 534 as the target set of ML functions.

At 616, the UE 602 may configure, based on the first indication, from a plurality of defined operational parameters, the one or more operational parameters associated with the target set of ML functions. For example, referring to FIG. 5, if the target set of ML functions include the sub-sub-functionalities 532 and 534, the UE may configure the one or more operational parameters based on the sub-sub-functionalities 532 and 534. For example, the one or more operational parameters may include parameters for the CSI report setting for reporting predicted results.

At 618, the UE 602 may communicate with the base station 604 based on one or more operational parameters associated with the target set of ML functions indicated from the plurality of defined ML functions. For example, referring to FIG. 5, based on the one or more operational parameters configured at 616, the UE may communicate with the base station 604.

At 620, the UE 602 may adjust the parameters of the CSI report setting based on the first indication. For example, referring to FIG. 5, if the first indication indicates that the target set of ML functions includes the sub-sub-functionalities 532 and 534, the UE may adjust the parameters of the CSI report setting based on the first indication.

At 622, the UE 602 may transmit a CSI report to the base station 604. For example, referring to FIG. 5, if the first indication indicates that the target set of ML functions includes the sub-sub-functionalities 532 and 534, the UE may transmit a CSI report to the base station, and the CSI report setting for the CSI report may be based on the sub-sub-functionalities 532 and 534.

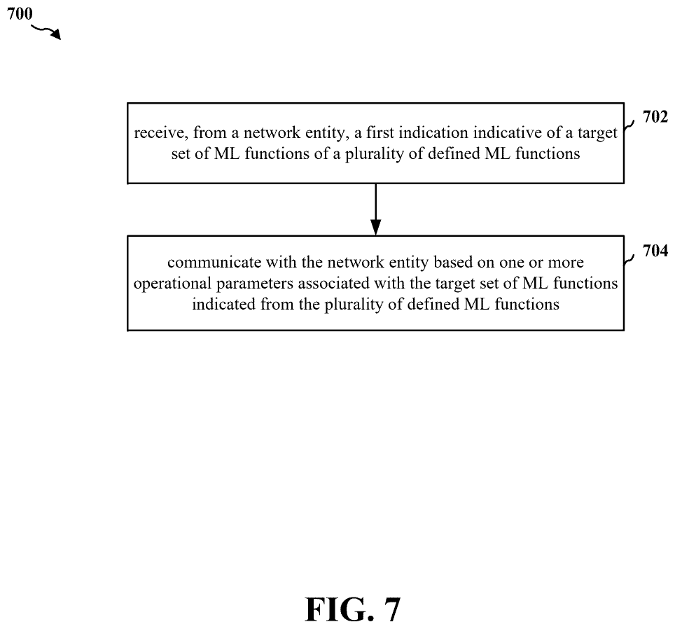

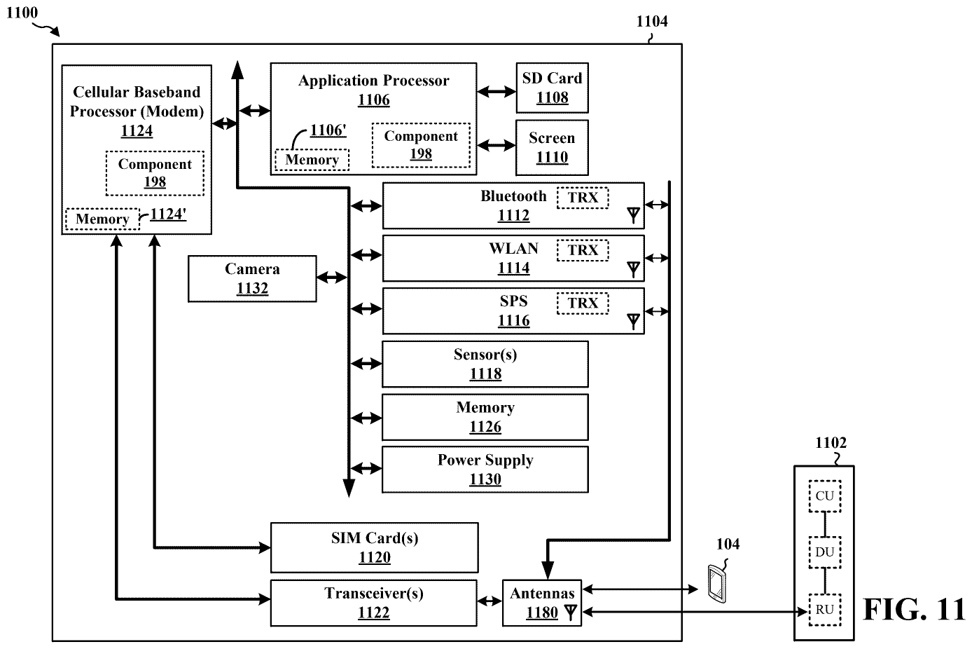

FIG. 7 is a flowchart 700 illustrating methods of wireless communication at a UE in accordance with various aspects of the present disclosure. The method may be performed by a UE. The UE may be the UE 104, 350, 602, or the apparatus 1104 in the hardware implementation of FIG. 11. The method provides new signaling frameworks dedicated to AI/ML model switch, and enables a UE to switch parameters for the ML functions with reduced overall signaling overhead. Thus, it improves the efficiency of wireless communication.

As shown in FIG. 7, at 702, the UE may receive, from a network entity, a first indication indicative of a target set of ML functions of a plurality of defined ML functions. The network entity may be a base station, or a component of a base station, in the access network of FIG. 1 or a core network component (e.g., base station 102, 310, 604; or the network entity 1102 in the hardware implementation of FIG. 11). FIGS. 5 and 6 illustrate various aspects of the steps in connection with flowchart 700. For example, referring to FIG. 6, the UE 602 may receive, at 614, from a network entity (base station 604), a first indication indicative of a target set of ML functions of a plurality of defined ML functions. Referring to FIG. 5, the target set of ML functions may include sub-sub-functionalities 532, 534, and 536. In some aspects, 702 may be performed by the AI/ML function switch component 198.

At 704, the UE may communicate with the network entity based on one or more operational parameters associated with the target set of ML functions indicated from the plurality of defined ML functions. For example, referring to FIG. 6, the UE 602 may communicate, at 618, with the network entity (base station 604) based on one or more operational parameters associated with the target set of ML functions indicated from the plurality of defined ML functions. In some aspects, 704 may be performed by the AI/ML function switch component 198.

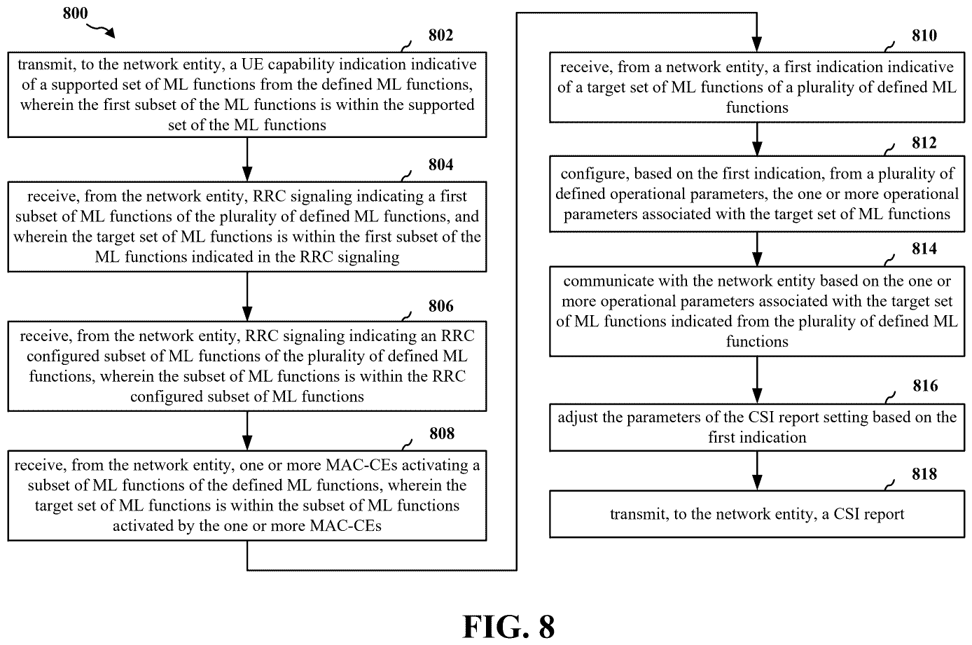

FIG. 8 is a flowchart 800 illustrating methods of wireless communication at a UE in accordance with various aspects of the present disclosure. The method may be performed by a UE. The UE may be the UE 104, 350, 602, or the apparatus 1104 in the hardware implementation of FIG. 11. The method provides new signaling frameworks dedicated to AI/ML model switch, and enables a UE to switch parameters for the ML functions with reduced overall signaling overhead. Thus, it improves the efficiency of wireless communication.

As shown in FIG. 8, at 810, the UE may receive, from a network entity, a first indication indicative of a target set of ML functions of a plurality of defined ML functions. The network entity may be a base station, or a component of a base station, in the access network of FIG. 1 or a core network component (e.g., base station 102, 310, 604; or the network entity 1102 in the hardware implementation of FIG. 11). FIGS. 5 and 6 illustrate various aspects of the steps in connection with flowchart 800. For example, referring to FIG. 6, the UE 602 may receive, at 614, from a network entity (base station 604), a first indication indicative of a target set of ML functions of a plurality of defined ML functions. Referring to FIG. 5, the target set of ML functions may include sub-sub-functionalities 532, 534, and 536. In some aspects, 810 may be performed by the AI/ML function switch component 198.

At 814, the UE may communicate with the network entity based on the one or more operational parameters associated with the target set of ML functions indicated from the plurality of defined ML functions. For example, referring to FIG. 6, the UE 602 may communicate, at 618, with the network entity (base station 604) based on one or more operational parameters associated with the target set of ML functions indicated from the plurality of defined ML functions. In some aspects, 814 may be performed by the AI/ML function switch component 198.

At 812, the UE may configure, based on the first indication, from a plurality of defined operational parameters, the one or more operational parameters associated with the target set of ML functions. For example, referring to FIG. 6, the UE 602 may configure, at 616, based on the first indication, from a plurality of defined operational parameters, the one or more operational parameters associated with the target set of ML functions. In some aspects, 812 may be performed by the AI/ML function switch component 198.

In some aspects, the plurality of defined ML functions may include one or more of: a beam prediction function, a CSF function, or a positioning function. For example, referring to FIG. 5, the plurality of defined ML functions may include one or more of a beam prediction function 512, a CSF function 514, or a positioning function 516.

In some aspects, to receive the first indication, the UE may be configured to: receive the first indication indicative of the target set of ML functions via one or more MAC-CEs or DCI. For example, referring to FIG. 6, when the UE 602 receives, at 614, the first indication, the UE may receive the first indication via one or more MAC-CEs or DCI.

In some aspects, ML functions in the plurality of defined ML functions may be indexed, and each ML function may be associated with a functionality ID according to a defined rule. For example, referring to FIG. 5, ML functions in the plurality of defined ML functions (e.g., TD beam prediction 522, SD beam prediction 524, and FD beam prediction 526) may be indexed, and each ML function (e.g., TD beam prediction 522, SD beam prediction 524, and FD beam prediction 526) may be associated with a functionality ID according to a defined rule.

In some aspects, a single MAC-CE or a single DCI may include the functionality IDs corresponding to the ML functions in the target set of ML functions. For example, referring to FIG. 6, when the UE 602 receives, at 614, the first indication indicating the target set of ML function through MAC-CE or DCI, the UE 602 may receive a single MAC-CE or a single DCI including the functionality IDs corresponding to the ML functions in the target set of ML functions.

In some aspects, the one or more MAC-CEs or DCI include multiple MAC-CEs or multiple DCIs. Each of the multiple MAC-CEs or the multiple DCIs may have a format associated with a corresponding ML functionality, and each of the multiple MAC-CEs or the multiple DCIs may include the functionality IDs for at least one of the target set of the ML functions associated with the corresponding ML functionality. For example, referring to FIG. 6, when the UE 602 receives, at 614, the first indication indicating the target set of ML function through MAC-CE or DCI, the UE 602 may receive multiple MAC-CEs or multiple DCI. Each of the multiple MAC-CEs or the multiple DCIs may have a format associated with a corresponding ML functionality, and each of the multiple MAC-CEs or the multiple DCIs may include the functionality IDs for at least one of the target set of the ML functions associated with the corresponding ML functionality.

At 804, the UE may receive, from the network entity, RRC signaling indicating a first subset of ML functions of the plurality of defined ML functions. The target set of ML functions may be within the first subset of the ML functions indicated in the RRC signaling. For example, referring to FIG. 6, the UE 602 may receive, at 608, from the network entity (base station 604), RRC signaling indicating a first subset of ML functions of the plurality of defined ML functions. The target set of ML functions (at 614) may be within the first subset of the ML functions indicated in the RRC signaling. In some aspects, 804 may be performed by the AI/ML function switch component 198.

At 802, the UE may transmit, to the network entity, a UE capability indication indicative of a supported set of ML functions from the defined ML functions. The first subset of the ML functions may be within the supported set of the ML functions. For example, referring to FIG. 6, the UE 602 may transmit, at 606, to the network entity (base station 604), a UE capability indication indicative of a supported set of ML functions from the defined ML functions. The first subset of the ML functions (at 614) may be within the supported set of the ML functions. In some aspects, 802 may be performed by the AI/ML function switch component 198.

At 808, the UE may receive, from the network entity, one or more MAC-CEs activating a subset of ML functions of the defined ML functions. The target set of ML functions may be within the subset of ML functions activated by the one or more MAC-CEs. For example, referring to FIG. 6, the UE 602 may receive, at 612, from the network entity (base station 604), one or more MAC-CEs activating a subset of ML functions of the defined ML functions. The target set of ML functions (at 614) may be within the subset of ML functions activated by the one or more MAC-CEs (at 612). In some aspects, 808 may be performed by the AI/ML function switch component 198.

In some aspects, the one or more MAC-CEs may include a single MAC-CE, including functionality IDs corresponding to the ML functions in the subset of the ML functions. For example, referring to FIG. 6, at 612, the one or more MAC-CEs may include a single MAC-CE, including functionality IDs corresponding to the ML functions in the subset of the ML functions.

In some aspects, the one or more MAC-CEs may include multiple MAC-CEs. Each of the multiple MAC-CEs may have a MAC-CE format associated with a corresponding ML functionality, and each of the multiple MAC-CEs may include an identifier for at least one of the target set of the ML functions associated with the corresponding ML functionality. For example, referring to FIG. 6, at 612, the one or more MAC-CEs may include multiple MAC-CEs. Each of the multiple MAC-CEs may have a MAC-CE format associated with a corresponding ML functionality, and each of the multiple MAC-CEs (at 612) may include an identifier for at least one of the target set of the ML functions associated with the corresponding ML functionality.

At 806, the UE may receive, from the network entity, RRC signaling indicating an RRC configured subset of ML functions of the plurality of defined ML functions. The subset of ML functions may be within the RRC configured subset of ML functions. For example, referring to FIG. 6, the UE 602 may receive, at 610, from the network entity (base station 604), RRC signaling indicating an RRC configured subset of ML functions of the plurality of defined ML functions. The subset of ML functions (at 612) may be within the RRC configured subset of ML functions. In some aspects, 806 may be performed by the AI/ML function switch component 198.

In some aspects, the plurality of defined operational parameters may include one or more: a first set of parameters related to UE ML interference behavior for the plurality of ML functions, a second set of parameters related to expected ML input and output for the plurality of ML functions, and a third set of parameters related to assistance information. For example, referring to FIG. 6, when the UE 602 configures, at 616, the one or more operational parameters from the plurality of defined operational parameters, the plurality of defined operational parameters may include one or more: a first set of parameters related to UE ML interference behavior for the plurality of ML functions, a second set of parameters related to expected ML input and output for the plurality of ML functions, and a third set of parameters related to assistance information.

In some aspects, the first set of parameters may include one or more of: a prediction parameter indicating a prediction type associated with the plurality of defined ML functions, a feedback parameter indicating feedback for channel characteristic prediction associated with the plurality of defined ML functions, and an accuracy parameter indicating an expected prediction accuracy or a confidence level associated with the plurality of defined ML functions. The second set of parameters may include one or more of: a first resource indicator for first measurement resources for inputs associated with the plurality of defined ML functions, a second resource indicator for predicted target resources for outputs associated with the plurality of defined ML functions, and a characteristic parameter indicating a relationship between the first measurement resources and the predicted target resources. The third set of parameters may include one or more of: a signaling indicator for an indication request associated with the plurality of defined ML functions, a target indicator for transmission of target results associated with the plurality of defined ML functions, and a measurement indicator for measurement of the target results associated with the plurality of defined ML functions. For example, referring to FIG. 6, when the UE 602 configures, at 616, the one or more operational parameters from the plurality of defined operational parameters, the first set of parameters (which are included in the plurality of defined operational parameters) may include one or more of: a prediction parameter indicating a prediction type associated with the plurality of defined ML functions, a feedback parameter indicating feedback for channel characteristic prediction associated with the plurality of defined ML functions, and an accuracy parameter indicating an expected prediction accuracy or a confidence level associated with the plurality of defined ML functions. The second set of parameters (which are included in the plurality of defined operational parameters) may include one or more of: a first resource indicator for first measurement resources for inputs associated with the plurality of defined ML functions, a second resource indicator for predicted target resources for outputs associated with the plurality of defined ML functions, and a characteristic parameter indicating a relationship between the first measurement resources and the predicted target resources. The third set of parameters (which are included in the plurality of defined operational parameters) may include one or more of: a signaling indicator for an indication request associated with the plurality of defined ML functions, a target indicator for transmission of target results associated with the plurality of defined ML functions, and a measurement indicator for measurement of the target results associated with the plurality of defined ML functions.

In some aspects, the prediction type may include one of more of: an SD beam prediction, a TD beam prediction, and an FD beam prediction. For example, referring to FIG. 5, the prediction type may include one of more of: an SD beam prediction 524, a TD beam prediction 522, and an FD beam prediction 526.

In some aspects, the channel characteristic prediction may include one or more: the predicted L1-RSRP, the predicted L1-SINR, CQI for a channel between the UE and the network entity, the RI, or predicted top-K prediction target resources associated with the predicted L1-RSRP and the predicted L1-SINR. For example, referring to FIG. 6, at 616, the channel characteristic prediction (which is included in the first set of parameters) may include one or more: the predicted L1-RSRP, the predicted L1-SINR, CQI for a channel between the UE and the network entity, the RI, or predicted top-K prediction target resources associated with the predicted L1-RSRP and the predicted L1-SINR

In some aspects, the ML function may include a TD beam prediction, and the first set of parameters may further include one or more of: a historical parameter indicating an association of historically measured resources with a set of spatial transmit filters associated with the ML function, and an accuracy adjustment parameter indicating an adjustment of accuracies or confidence levels for different future prediction occasions of the ML function. The second set of parameters may further include one or more of: an interval parameter indicating intervals between adjacent measurement occasions and between adjacent prediction occasions, and a future prediction parameter indicating a number of future prediction occasions. For example, referring to FIG. 6, when the plurality of defined ML functions includes a TD beam prediction, the first set of parameters (which the UE 602 may configure at 616) may further include one or more of: a historical parameter indicating an association of historically measured resources with a set of spatial transmit filter associated with the ML function, and an accuracy adjustment parameter indicating an adjustment of accuracies or confidence levels for different future prediction occasions of the ML function. The second set of parameters may further include one or more of: an interval parameter indicating intervals between adjacent measurement occasions and between adjacent prediction occasions, and a future prediction parameter indicating a number of future prediction occasions.

In some aspects, the ML function may include an FD beam prediction, and the first set of parameters may further include one or more of: FRs or CCs conveying second measurement resources and prediction targets, an accuracy adjustment parameter indicating an adjustment of accuracies or confidence levels for different FRs or CCs of the ML function. The second set of parameters may further include a TD association parameter indicating a first association of the prediction target with TD occasions of the ML function. The third set of parameters may further include one or more of: a co-location indicator indicating a second association of third measurement resources with antennas, and a location parameter indicating location information of the antennas of the network entity. For example, referring to FIG. 6, when the plurality of defined ML functions includes an FD beam prediction, and the first set of parameters (which the UE 602 may configure at 616) may further include one or more of: FRs or CCs conveying second measurement resources and prediction targets, an accuracy adjustment parameter indicating an adjustment of accuracies or confidence levels for different FRs or CCs of the ML function. The second set of parameters may further include a TD association parameter indicating a first association of the prediction target with TD occasions of the ML function. The third set of parameters may further include one or more of: a co-location indicator indicating a second association of third measurement resources with antennas, and a location parameter indicating location information of the antennas of the network entity

At 818, the UE may transmit, to the network entity, a CSI report. The parameters of a CSI report setting for the CSI report may include: a functionality ID for a main function associated with the target set of ML functions, and prediction information associated with the target set of ML functions. For example, referring to FIG. 6, the UE 602 may transmit, at 622, to the network entity (base station 604), a CSI report. The parameters of a CSI report setting for the CSI report may include: a functionality ID for a main function associated with the target set of ML functions, and prediction information associated with the target set of ML functions. In some aspects, 818 may be performed by the AI/ML function switch component 198.

In some aspects, the prediction information may include: predicted channel characteristics for a channel between the UE and the network entity, CMR, where the CMR may be used as inputs to identify the predicted channel characteristics, and a prediction resource set identifying the targets of the prediction of the channel characteristics. For example, referring to FIG. 6, at 622, the prediction information (one of the parameters of the CSI report setting for the CSI report) may include: predicted channel characteristics for a channel between the UE and the network entity, CMR, where the CMR may be used as inputs to identify the predicted channel characteristics, and a prediction resource set identifying the targets of the prediction of the channel characteristics.

At 816, the UE may adjust the parameters of the CSI report setting based on the first indication. The parameters may be adjusted without signaling from the network entity. For example, referring to FIG. 6, the UE 602 may adjust, at 620, the parameters of the CSI report setting based on the first indication. The parameters may be adjusted without signaling from the network entity (base station 604). In some aspects, 816 may be performed by the AI/ML function switch component 198.

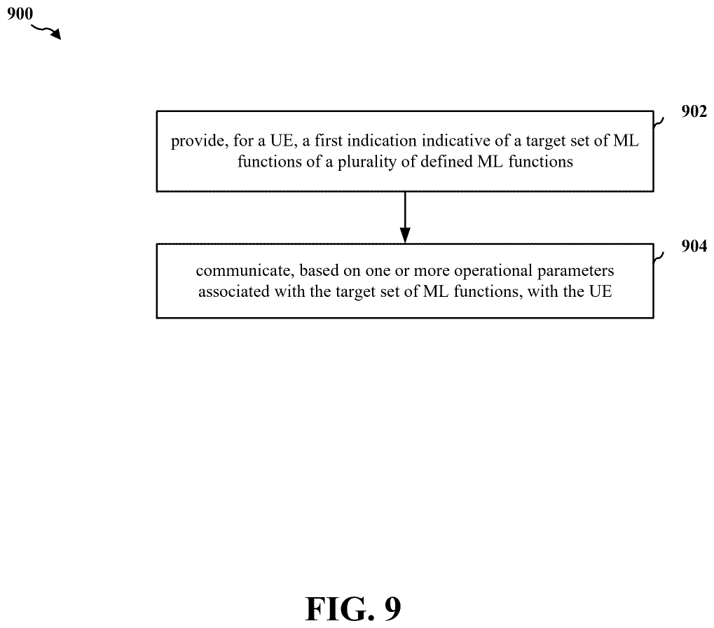

FIG. 9 is a flowchart 900 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 604; or the network entity 1102 in the hardware implementation of FIG. 11). The method provides new signaling frameworks dedicated to AI/ML model switch, and enables a UE to switch parameters for the ML functions with reduced overall signaling overhead. Thus, it improves the efficiency of wireless communication.

As shown in FIG. 9, at 902, the network entity may provide, for a UE, a first indication indicative of a target set of ML functions of a plurality of defined ML functions. The UE may be the UE 104, 350, 602, or the apparatus 1104 in the hardware implementation of FIG. 11. FIGS. 5 and 6 illustrate various aspects of the steps in connection with flowchart 900. For example, referring to FIG. 6, the network entity (base station 604) may provide, at 614, for a UE 602, a first indication indicative of a target set of ML functions of a plurality of defined ML functions. In some aspects, 902 may be performed by the AI/ML function switch component 199.

At 904, the network entity may communicate, based on one or more operational parameters associated with the target set of ML functions, with the UE. For example, referring to FIG. 6, the network entity (base station 604) may communicate, at 618, based on one or more operational parameters associated with the target set of ML functions, with the UE 602. In some aspects, 904 may be performed by the AI/ML function switch component 199.

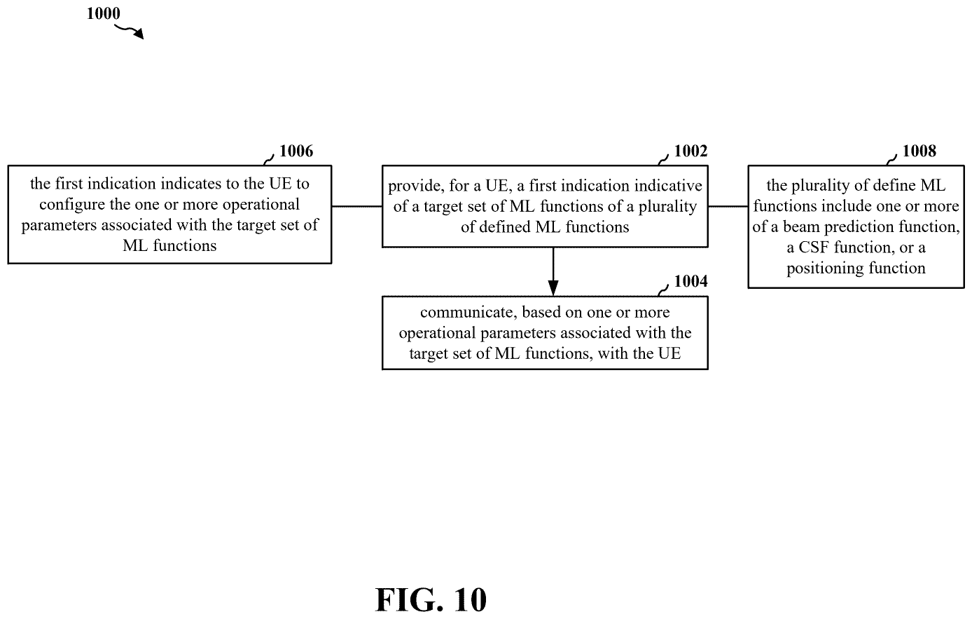

FIG. 10 is a flowchart 1000 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 604; or the network entity 1102 in the hardware implementation of FIG. 11). The method provides new signaling frameworks dedicated to AI/ML model switch, and enables a UE to switch parameters for the ML functions with reduced overall signaling overhead. Thus, it improves the efficiency of wireless communication.

As shown in FIG. 10, at 1002, the network entity may provide, for a UE, a first indication indicative of a target set of ML functions of a plurality of defined ML functions. The UE may be the UE 104, 350, 602, or the apparatus 1104 in the hardware implementation of FIG. 11. FIGS. 5 and 6 illustrate various aspects of the steps in connection with flowchart 1000. For example, referring to FIG. 6, the network entity (base station 604) may provide, at 614, for a UE 602, a first indication indicative of a target set of ML functions of a plurality of defined ML functions. In some aspects, 1002 may be performed by the AI/ML function switch component 199.

At 1004, the network entity may communicate, based on one or more operational parameters associated with the target set of ML functions, with the UE. For example, referring to FIG. 6, the network entity (base station 604) may communicate, at 618, based on one or more operational parameters associated with the target set of ML functions, with the UE 602. In some aspects, 1004 may be performed by the AI/ML function switch component 199.

In some aspects, at 1006, the first indication may indicate to the UE to configure the one or more operational parameters associated with the target set of ML functions. For example, referring to FIG. 6, the first indication (at 614) may indicate to the UE 602 to configure, at 616, the one or more operational parameters associated with the target set of ML functions.

In some aspects, at 1008, the plurality of defined ML functions may include one or more of: a beam prediction function, a CSF function, or a positioning function. For example, referring to FIG. 5, the plurality of defined ML functions may include one or more of: a beam prediction function 512, a CSF function 514, or a positioning function 516.

In some aspects, to provide the first indication, the network entity may be configured to: provide the first indication indicative of the target set of ML functions via one or more MAC-CEs or DCI. For example, referring to FIG. 6, when the network entity (base station 604) provides the first indication (at 614), the network entity (base station 604) may provide the first indication via one or more MAC-CEs or DCI.

In some aspects, the ML functions in the plurality of defined ML functions may be indexed, and each ML function is associated with a functionality ID according to a defined rule. For example, referring to FIG. 5, ML functions in the plurality of defined ML functions (e.g., TD beam prediction 522, SD beam prediction 524, and FD beam prediction 526) may be indexed, and each ML function (e.g., TD beam prediction 522, SD beam prediction 524, and FD beam prediction 526) may be associated with a functionality ID according to a defined rule.

In some aspects, a single MAC-CE or a single DCI may include the functionality IDs corresponding to the ML functions in the target set of ML functions. For example, referring to FIG. 6, when the network entity (base station 604) provides the first indication (at 614), the network entity (base station 604) may provide the first indication via a single MAC-CE or a single DCI, and the single MAC-CE or the single DCI may include the functionality IDs corresponding to the ML functions in the target set of ML functions.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor (or processing circuitry) 1124 (also referred to as a modem) coupled to one or more transceivers 1122 (e.g., cellular RF transceiver). The cellular baseband processor(s) (or processing circuitry) 1124 may include at least one on-chip memory (or memory circuitry) 1124′. In some aspects, the apparatus 1104 may further include one or more subscriber identity modules (SIM) cards 1120 and at least one application processor (or processing circuitry) 1106 coupled to a secure digital (SD) card 1108 and a screen 1110. The application processor(s) (or processing circuitry) 1106 may include on-chip memory (or memory circuitry) 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) (or processing circuitry) 1124 communicates through the transceiver(s) 1122 via one or more antennas 1180 with the UE 104 and/or with an RU associated with a network entity 1102. The cellular baseband processor(s) (or processing circuitry) 1124 and the application processor(s) (or processing circuitry) 1106 may each include a computer-readable medium/memory (or memory circuitry) 1124′, 1106′, respectively. The additional memory modules 1126 may also be considered a computer-readable medium/memory (or memory circuitry). Each computer-readable medium/memory (or memory circuitry) 1124′, 1106′, 1126 may be non-transitory. The cellular baseband processor(s) (or processing circuitry) 1124 and the application processor(s) (or processing circuitry) 1106 are each responsible for general processing, including the execution of software stored on the computer-readable medium/memory (or memory circuitry). The software, when executed by the cellular baseband processor(s) (or processing circuitry) 1124/application processor(s) (or processing circuitry) 1106, causes the cellular baseband processor(s) (or processing circuitry) 1124/application processor(s) (or processing circuitry) 1106 to perform the various functions described supra. The cellular baseband processor(s) (or processing circuitry) 1124 and the application processor(s) (or processing circuitry) 1106 are configured to perform the various functions described supra based at least in part of the information stored in the memory. That is, the cellular baseband processor(s) (or processing circuitry) 1124 and the application processor(s) (or processing circuitry) 1106 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1124/application processor(s) (or processing circuitry) 1106 when executing software. The cellular baseband processor(s) (or processing circuitry) 1124/application processor(s) (or processing circuitry) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) (or processing circuitry) 1124 and/or the application processor(s) (or processing circuitry) 1106, and in another configuration, the apparatus 1104 may be the entire UE (e.g., see UE 350 of FIG. 3) and include the additional modules of the apparatus 1104.

As discussed supra, the component 198 may be configured to receive, from a network entity, a first indication indicative of a target set of ML functions of a plurality of defined ML functions; and communicate with the network entity based on one or more operational parameters associated with the target set of ML functions indicated from the plurality of defined ML functions. The component 198 may be further configured to perform any of the aspects described in connection with the flowcharts in FIG. 7 and FIG. 8, and/or performed by the UE 602 in FIG. 6. The component 198 may be within the cellular baseband processor(s) (or processing circuitry) 1124, the application processor(s) (or processing circuitry) 1106, or both the cellular baseband processor(s) (or processing circuitry) 1124 and the application processor(s) (or processing circuitry) 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) (or processing circuitry) 1124 and/or the application processor(s) (or processing circuitry) 1106, may include means for receiving, from a network entity, a first indication indicative of a target set of ML functions of a plurality of defined ML functions, and means for communicating with the network entity based on one or more operational parameters associated with the target set of ML functions indicated from the plurality of defined ML functions. The apparatus 1104 may further include means for performing any of the aspects described in connection with the flowcharts in FIG. 7 and FIG. 8, and/or aspects performed by the UE 602 in FIG. 6. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

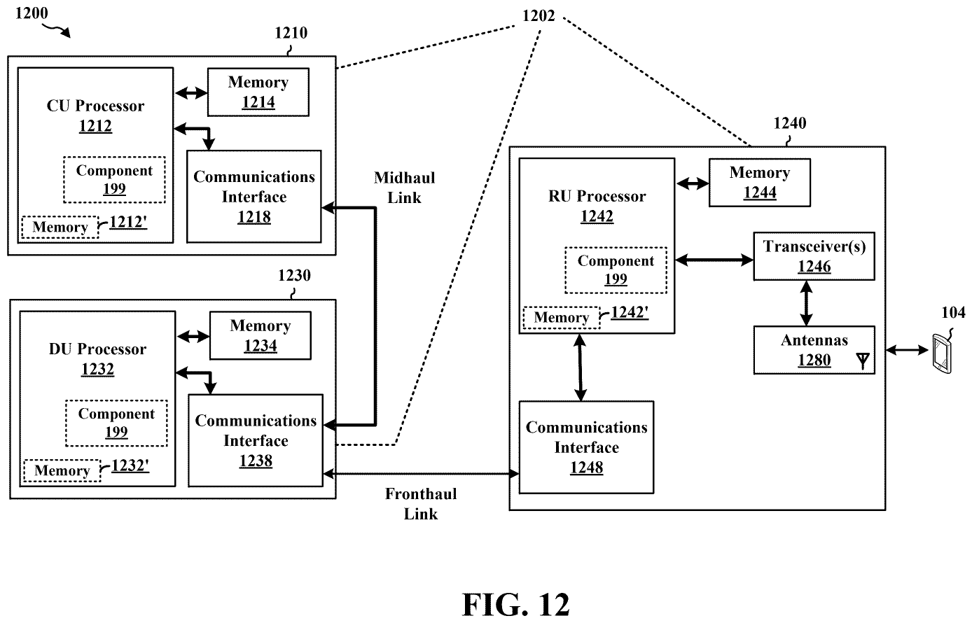

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor (or processing circuitry) 1212. The CU processor(s) (or processing circuitry) 1212 may include on-chip memory (or memory circuitry) 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor (or processing circuitry) 1232. The DU processor(s) (or processing circuitry) 1232 may include on-chip memory (or memory circuitry) 1232′. In some aspects, the DU 1230 may further include additional memory modules 1234 and a communications interface 1238. The DU 1230 communicates with the RU 1240 through a fronthaul link. The RU 1240 may include at least one RU processor (or processing circuitry) 1242. The RU processor(s) (or processing circuitry) 1242 may include on-chip memory (or memory circuitry) 1242′. In some aspects, the RU 1240 may further include additional memory modules 1244, one or more transceivers 1246, antennas 1280, and a communications interface 1248. The RU 1240 communicates with the UE 104. The on-chip memory (or memory circuitry) 1212′, 1232′, 1242′ and the additional memory modules 1214, 1234, 1244 may each be considered a computer-readable medium/memory (or memory circuitry). Each computer-readable medium/memory (or memory circuitry) may be non-transitory. Each of the processors (or processing circuitry) 1212, 1232, 1242 is responsible for general processing, including the execution of software stored on the computer-readable medium/memory (or memory circuitry). The software, when executed by the corresponding processor(s) causes the processor(s) to perform the various functions described supra. The computer-readable medium/memory (or memory circuitry) may also be used for storing data that is manipulated by the processor(s) when executing software.

As discussed supra, the component 199 may be configured to provide, for a UE, a first indication indicative of a target set of ML functions of a plurality of defined ML functions; and communicate, based on one or more operational parameters associated with the target set of ML functions, with the UE. The component 199 may be further configured to perform any of the aspects described in connection with the flowcharts in FIG. 9 and FIG. 10, and/or performed by the base station 604 in FIG. 6. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 may include means for providing, for a UE, a first indication indicative of a target set of ML functions of a plurality of defined ML functions, and means for communicating, based on one or more operational parameters associated with the target set of ML functions, with the UE. The network entity 1202 may further include means for performing any of the aspects described in connection with the flowcharts in FIG. 9 and FIG. 10, and/or aspects performed by the base station 604 in FIG. 6. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include receiving, from a network entity, a first indication indicative of a target set of ML functions of a plurality of defined ML functions; and communicating with the network entity based on one or more operational parameters associated with the target set of ML functions indicated from the plurality of defined ML functions. The method provides new signaling frameworks dedicated to AI/ML model switch, and enables a UE to switch parameters for the ML functions with reduced overall signaling overhead. Thus, it improves the efficiency of wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method may include receiving, from a network entity, a first indication indicative of a target set of ML functions of a plurality of defined ML functions; and communicating with the network entity based on one or more operational parameters associated with the target set of ML functions indicated from the plurality of defined ML functions.

Aspect 2 is the method of aspect 1, where the method may further include configuring, based on the first indication, from a plurality of defined operational parameters, the one or more operational parameters associated with the target set of ML functions.

Aspect 3 is the method of any of aspects 1 to 2, where the plurality of defined ML functions may include one or more of: a beam prediction function, a CSF function, or a positioning function.

Aspect 4 is the method of any of aspects 1 to 3, where receiving the first indication may include: receiving the first indication indicative of the target set of ML functions via one or more MAC-CEs or DCI.

Aspect 5 is the method of aspect 4, where the ML functions in the plurality of defined ML functions may be indexed, and each ML function may be associated with a functionality ID according to a defined rule.

Aspect 6 is the method of aspect 5, where a single MAC-CE or a single DCI may include the functionality IDs corresponding to the ML functions in the target set of ML functions.

Aspect 7 is the method of aspect 5, where the one or more MAC-CEs or DCI may include multiple MAC-CEs or multiple DCIs, each of the multiple MAC-CEs or the multiple DCIs having a format associated with a corresponding ML functionality. Each of the multiple MAC-CEs or the multiple DCIs may include the functionality IDs for at least one of the target set of the ML functions associated with the corresponding ML functionality.

Aspect 8 is the method of any of aspects 1 to 7, where the method may further include: prior to receiving the first indication: receiving, from the network entity, RRC signaling indicating a first subset of ML functions of the plurality of defined ML functions. The target set of ML functions may be within the first subset of the ML functions indicated in the RRC signaling.

Aspect 9 is the method of aspect 8, where the method may further include: transmitting, to the network entity, a UE capability indication indicative of a supported set of ML functions from the defined ML functions. The first subset of the ML functions may be within the supported set of the ML functions.

Aspect 10 is the method of any of aspects 1 to 9, where the method may further include: prior to receiving the first indication, receiving, from the network entity, one or more MAC-CEs activating a subset of ML functions of the defined ML functions. The target set of ML functions may be within the subset of ML functions activated by the one or more MAC-CEs.

Aspect 11 is the method of aspect 10, where the one or more MAC-CE may include a single MAC-CE, including functionality IDs corresponding to the ML functions in the subset of the ML functions.

Aspect 12 is the method of aspect 10, where the one or more MAC-CEs may include multiple MAC-CEs. Each of the multiple MAC-CEs may have a MAC-CE format associated with a corresponding ML functionality, and each of the multiple MAC-CEs may include an identifier for at least one of the target set of the ML functions associated with the corresponding ML functionality.

Aspect 13 is the method of aspect 10, where the method may further include: prior to receiving the first indication: receiving, from the network entity, RRC signaling indicating an RRC configured subset of ML functions of the plurality of defined ML functions. The subset of ML functions may be within the RRC configured subset of ML functions.

Aspect 14 is the method of aspect 3, where the plurality of defined operational parameters may include one or more: a first set of parameters related to UE ML interference behavior for the plurality of ML functions, a second set of parameters related to expected ML input and output for the plurality of ML functions, and a third set of parameters related to assistance information.

Aspect 15 is the method of aspect 14, where the first set of parameters include one or more of: a prediction parameter indicating a prediction type associated with the plurality of defined ML functions, a feedback parameter indicating feedback for channel characteristic prediction associated with the plurality of defined ML functions, and an accuracy parameter indicating an expected prediction accuracy or a confidence level associated with the plurality of defined ML functions. The second set of parameters may include one or more of: a first indicator for first measurement resources for inputs associated with the plurality of defined ML functions, a second resource indicator for predicted target resources for outputs associated with the plurality of defined ML functions, and a characteristic parameter indicating a relationship between the first measurement resources and the predicted target resources. The third set of parameters may include one or more of: a signaling indicator for an indication request associated with the plurality of defined ML functions, a target indicator for transmission of target results associated with the plurality of defined ML functions, and a measurement indicator for measurement of the target results associated with the plurality of defined ML functions.

Aspect 16 is the method of aspect 15, where the prediction type may include one of more of: a spatial domain beam prediction, a temporal domain beam prediction, and a frequency domain beam prediction.

Aspect 17 is the method of aspect 15, where the channel characteristic prediction may include one or more: the predicted L1-RSRP, the predicted L1-SINR, CQI for a channel between the UE and the network entity, the RI, or predicted top-K prediction target resources associated with the predicted L1-RSRP and the predicted L1-SINR.

Aspect 18 is the method of aspect 15, where the ML function may include a temporal domain beam prediction. The first set of parameters may further include one or more of: a historical parameter indicating an association of historically measured resources with a set of spatial transmit filter associated with the ML function, and an accuracy adjustment parameter indicating an adjustment of accuracies or confidence levels for different future prediction occasions of the ML function. The second set of parameters may further include one or more of: an interval parameter indicating intervals between adjacent measurement occasions and between adjacent prediction occasions, and a future prediction parameter indicating a number of future prediction occasions.

Aspect 19 is the method of any of aspects 15, where the ML function may include a frequency domain beam prediction, and the first set of parameters may further include one or more of: FRs or CCs conveying second measurement resources and prediction targets, an accuracy adjustment parameter indicating an adjustment of accuracies or confidence levels for different FRs or CCs of the ML function. The second set of parameters may further include: a TD association parameter indicating a first association of the prediction target with TD occasions of the ML function. The third set of parameters may further include one or more of: a co-location indicator indicating a second association of third measurement resources with antennas, and a location parameter indicating location information of the antennas of the network entity.

Aspect 20 is the method of any of aspects 1 to 19, where the method may further include transmitting, to the network entity, a CSI report, where parameters of a CSI report setting for the CSI report may include: a functionality ID for a main function associated with the target set of ML functions, and prediction information associated with the target set of ML functions.

Aspect 21 is the method of aspect 20, where the prediction information may include: predicted channel characteristics for a channel between the UE and the network entity, CMR, where the CMR is used as inputs to identify the predicted channel characteristics, and a prediction resource set identifying the targets of the prediction of the channel characteristics.

Aspect 22 is the method of aspect 20, where the method may further include adjusting the parameters of the CSI report setting based on the first indication. The parameters may be adjusted without signaling from the network entity.

Aspect 23 is an apparatus for wireless communication at a UE, comprising: a processing system that includes processor circuitry and memory circuitry that stores code and is coupled with the processor circuitry, the processing system configured to cause the UE to perform the method of one or more of aspects 1-22.

Aspect 24 is an apparatus for wireless communication at a UE, including: at least one memory; and at least one processor coupled to the at least one memory and, based at least in part on information stored in the at least one memory, the at least one processor, individually or in any combination, is configured to perform the method of any of aspects 1-22.

Aspect 25 is an apparatus for wireless communication at a UE, including means for implementing the method of any of aspects 1-22.

Aspect 26 is the apparatus of any of aspects 23-25, further including a transceiver configured to receive or transmit in association with the method of any of aspects 1-22.

Aspect 27 is a computer-readable medium (e.g., a non-transitory computer-readable medium) storing computer executable code at a UE, where the code when executed by at least one processor causes the at least one processor, individually or in any combination, to implement the method of any of aspects 1-22.

Aspect 28 is a method of wireless communication at a network entity. The method may include providing, for a UE, a first indication indicative of a target set of ML functions of a plurality of defined ML functions; and communicating, based on one or more operational parameters associated with the target set of ML functions, with the UE.

Aspect 29 is the method of aspect 28, where the first indication may indicate to the UE to configure the one or more operational parameters associated with the target set of ML functions.

Aspect 30 is the method of any of aspects 28 to 29, where the plurality of defined ML functions may include one or more of: a beam prediction function, a CSF function, or a positioning function.

Aspect 31 is the method of any of aspects 28 to 30, where providing the first indication may include: providing the first indication indicative of the target set of ML functions via one or more MAC-CEs or DCI.

Aspect 32 is the method of aspect 31, where ML functions in the plurality of defined ML functions may be indexed, and each ML function may be associated with a functionality ID according to a defined rule.

Aspect 33 is the method of aspect 32, where a single MAC-CE or a single DCI may include the functionality IDs corresponding to the ML functions in the target set of ML functions.

Aspect 34 is an apparatus for wireless communication at a network entity, comprising: a processing system that includes processor circuitry and memory circuitry that stores code and is coupled with the processor circuitry, the processing system configured to cause the network entity to perform the method of one or more of aspects 28-33.

Aspect 35 is an apparatus for wireless communication at a network entity, including: at least one memory; and at least one processor coupled to the at least one memory and, based at least in part on information stored in the at least one memory, the at least one processor, individually or in any combination, is configured to perform the method of any of aspects 28-33.

Aspect 36 is an apparatus for wireless communication including means for implementing the method of any of aspects 28-33.

Aspect 37 is the apparatus of any of aspects 34-36, further including at least a transceiver configured to receive or to transmit in association with the method of any of aspects 28-33.

Aspect 38 is a computer-readable medium (e.g., a non-transitory computer-readable medium) storing computer executable code at a network entity, where the code when executed by at least one processor causes the at least one processor, individually or in any combination, to implement the method of any of aspects 28-33.

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to cause the UE to:
receive, from a network entity, a first indication indicative of a target set of machine learning (ML) functions of a plurality of defined ML functions; and
communicate with the network entity based on one or more operational parameters associated with the target set of ML functions indicated from the plurality of defined ML functions.

2. The apparatus of claim 1, further comprising a transceiver coupled to the at least one processor, wherein, to receive the first indication, the at least one processor, individually or in any combination, is configured to cause the UE to receive the first indication via the transceiver, and wherein the at least one processor, individually or in any combination, is further configured to cause the UE to:
configure, based on the first indication, from a plurality of defined operational parameters, the one or more operational parameters associated with the target set of ML functions, wherein the plurality of defined ML functions includes one or more of:
a beam prediction function,
a channel state feedback (CSF) function, or
a positioning function.

3. The apparatus of claim 2, wherein, to receive the first indication, the at least one processor, individually or in any combination, is configured to cause the UE to:
receive the first indication indicative of the target set of ML functions via one or more medium access control-control elements (MAC-CEs) or downlink control information (DCI).

4. The apparatus of claim 3, wherein ML functions in the plurality of defined ML functions are indexed, and each ML function is associated with a functionality identifier (ID) according to a defined rule.

5. The apparatus of claim 4, wherein a single MAC-CE or a single DCI comprise functionality IDs corresponding to the ML functions in the target set of ML functions.

6. The apparatus of claim 4, wherein the one or more MAC-CEs or DCI include multiple MAC-CEs or multiple DCIs, each of the multiple MAC-CEs or the multiple DCIs having a format associated with a corresponding ML functionality, and each of the multiple MAC-CEs or the multiple DCIs including the functionality ID for at least one of the target set of ML functions associated with the corresponding ML functionality.

7. The apparatus of claim 1, wherein the at least one processor, individually or in any combination, is further configured to cause the UE to, prior to being configured to receive the first indication:
receive, from the network entity, radio resource control (RRC) signaling indicating a first subset of ML functions of the plurality of defined ML functions, and wherein the target set of ML functions is within the first subset of the ML functions indicated in the RRC signaling.

8. The apparatus of claim 7, wherein the at least one processor, individually or in any combination, is further configured to cause the UE to:
transmit, to the network entity, a UE capability indication indicative of a supported set of ML functions from the plurality of defined ML functions, wherein the first subset of the ML functions is within the supported set of ML functions.

9. The apparatus of claim 1, wherein the at least one processor, individually or in any combination, is further configured to cause the UE to, prior to being configured to receive the first indication:
receive, from the network entity, one or more medium access control-control elements (MAC-CEs) activating a subset of ML functions of the plurality of defined ML functions, wherein the target set of ML functions is within the subset of ML functions activated by the one or more MAC-CEs.

10. The apparatus of claim 9, wherein the one or more MAC-CEs include a single MAC-CE, comprising functionality identifiers (IDs) corresponding to the ML functions in the subset of the ML functions.

11. The apparatus of claim 9, wherein the one or more MAC-CEs include multiple MAC-CEs, each of the multiple MAC-CEs having a MAC-CE format associated with a corresponding ML functionality, and each of the multiple MAC-CEs including an identifier for at least one of the target set of ML functions associated with the corresponding ML functionality.

12. The apparatus of claim 9, wherein the at least one processor, individually or in any combination, is further configured to cause the UE to, prior to being configured to receive the first indication:
receive, from the network entity, radio resource control (RRC) signaling indicating an RRC configured subset of ML functions of the plurality of defined ML functions, wherein the subset of ML functions activated by the one or more MAC-CEs is within the RRC configured subset of ML functions

13. The apparatus of claim 2, wherein the plurality of defined operational parameters comprises one or more:
a first set of parameters related to UE ML interference behavior for the plurality of defined ML functions,
a second set of parameters related to expected ML input and output for the plurality of defined ML functions, and
a third set of parameters related to assistance information.

14. The apparatus of claim 13, wherein the first set of parameters include one or more of:
a prediction parameter indicating a prediction type associated with the plurality of defined ML functions, wherein the prediction type includes one of more of a spatial domain beam prediction, a temporal domain beam prediction, and a frequency domain beam prediction, a feedback parameter indicating feedback for channel characteristic prediction associated with the plurality of defined ML functions, or
an accuracy parameter indicating an expected prediction accuracy or a confidence level associated with the plurality of defined ML functions, and
the second set of parameters include one or more of:
a first resource indicator for first measurement resources for inputs associated with the plurality of defined ML functions,
a second resource indicator for predicted target resources for outputs associated with the plurality of defined ML functions, and
a characteristic parameter indicating a relationship between the first measurement resources and the predicted target resources, and
the third set of parameters include one or more of:
a signaling indicator for an indication request associated with the plurality of defined ML functions,
a target indicator for transmission of target results associated with the plurality of defined ML functions, and
a measurement indicator for measurement of the target results associated with the plurality of defined ML functions.

15. The apparatus of claim 14, wherein the channel characteristic prediction includes one or more:
a predicted layer 1 Reference Signal Received Power (L1-RSRP),
a predicted layer 1 Signal-to-Interference-plus-Noise Ratio (L1-SINR),
Channel Quality Indicator (CQI) for a channel between the UE and the network entity,
a rank indicator (RI), or
predicted top-K prediction target resources associated with the predicted L1-RSRP and the predicted L1-SINR.

16. The apparatus of claim 14, wherein a target ML function includes the temporal domain beam prediction, and the first set of parameters further include one or more of:
a historical parameter indicating an association of historically measured resources with a set of spatial transmit filter associated with the target ML function, or
an accuracy adjustment parameter indicating an adjustment of accuracies or confidence levels for different future prediction occasions of the target ML function, and
the second set of parameters further include one or more of:
an interval parameter indicating intervals between adjacent measurement occasions and between adjacent prediction occasions, or
a future prediction parameter indicating a number of future prediction occasions.

17. The apparatus of claim 14, wherein a target ML function includes the frequency domain beam prediction, and the first set of parameters further include one or more of:
frequency ranges (FRs) or component carriers (CCs) conveying second measurement resources and prediction targets,
an accuracy adjustment parameter indicating an adjustment of accuracies or confidence levels for different FRs or CCs of the target ML function,
the second set of parameters further include a TD association parameter indicating a first association of a prediction target with TD occasions of the target ML function, or
the third set of parameters further include one or more of:
a co-location indicator indicating a second association of third measurement resources with antennas, and
a location parameter indicating location information of the antennas of the network entity.

18. The apparatus of claim 2, wherein the at least one processor, individually or in any combination, is further configured to cause the UE to:
transmit, to the network entity, a channel state information (CSI) report, wherein parameters of a CSI report setting for the CSI report includes:
a functionality ID for a main function associated with the target set of ML functions, and prediction information associated with the target set of ML functions, wherein the prediction information includes:
predicted channel characteristics for a channel between the UE and the network entity, coordinated multipoint reception (CMR), wherein the CMR is used as inputs to identify the predicted channel characteristics, and
a prediction resource set identifying prediction targets of the predicted channel characteristics.

19. The apparatus of claim 18, wherein the at least one processor, individually or in any combination, is further configured to cause the UE to:
adjust the parameters of the CSI report setting based on the first indication, wherein the parameters are adjusted without signaling from the network entity.

20-25. (canceled)

26. A method of wireless communication at a user equipment (UE), comprising:
receiving, from a network entity, a first indication indicative of a target set of machine learning (ML) functions of a plurality of defined ML functions; and
communicating with the network entity based on one or more operational parameters associated with the target set of ML functions indicated from the plurality of defined ML functions.

27. The method of claim 26, further comprising:
configuring, based on the first indication, from a plurality of defined operational parameters, the one or more operational parameters associated with the target set of ML functions, wherein the plurality of defined ML functions includes one or more of:
a beam prediction function,
a channel state feedback (CSF) function, or
a positioning function.

28-30. (canceled)
